(19) United States
(12) Patent Application Publication
(10) Pub. No.: US 2017/0240816 A1
(43) Pub. Date: Aug. 24, 2017

(54) SEPARATION OF HYDROCARBONS FROM INORGANIC MATERIAL

(71) Applicant: ENNOX TECHNOLOGY AS, Skien (NO)

(72) Inventors: Mathias WILICHOWSKI, Bäk (DE); Knut HANSEN, Sandefjord (NO); Eivind SINGDAHLSEN, Sandefjord (NO); John A. HESTENES HANSEN, Sandefjord (NO)

(73) Assignee: ENNOX TECHNOLOGY AS, Skien (NO)

(21) Appl. No.: 15/516,845

(22) PCT Filed: Oct. 21, 2015
(86) PCT No.: PCT/NO2015/000026

§ 371 Date: Apr. 4, 2017

(30) Foreign Application Priority Data
Oct. 22, 2014 (NO) 20141256

(51) Int. Cl. C10G 1/00; B01D 17/02; B01D 21/24; B01D 21/28

(52) U.S. Cl. CPC C10G 1/00; B01D 21/283; B01D 17/0217; B01D 21/2461; C10G 2300/4012

(57) ABSTRACT

An apparatus for separating hydrocarbons from solid particles includes a slurry inlet for receiving a slurry including water, hydrocarbons and solid particles, a water supply for rinsing water, and a slurry outlet. The apparatus further includes a plurality of nozzles configured to provide rinsing water as droplets with sufficient speed to induce cavitation in the slurry, and a separator for extracting a liquid containing water and hydrocarbons from the slurry and a separate liquid outlet for the extracted liquid.

### BACKGROUND

Field of the Invention

The present invention concerns an apparatus and a system for separating hydrocarbons from solid material.

Prior and Related Art

Separating hydrocarbons from solid material is desired in many applications, for example cleaning up old dumpsites for drill cuttings, removing oil from new drill cuttings to make them suitable for a landfill, extracting hydrocarbons from tar sand or shale, etc. As used herein, “solid material” means pieces of rock and/or ice of arbitrary size. For example, ice may be included in tar sand or landfills in arctic regions, or there may be a need for extracting oil from ice after an oil spill.

Biological methods use microbes that feed on long hydrocarbon chains or aromatic components. Typically, these methods do not require grinding the solid material into smaller particles, and the may produce methane and/or hydrogen gas. However, biological methods require heat and typically have long processing times, both of which make them unsuitable for fast, compact and inexpensive processing, especially in arctic regions.

In some applications, an initial mixture containing ice may simply be left outdoors until the ice melts, and then proceed through any known method or apparatus for separating oil, water and rock particles. However, in some applications the heat required to melt the ice must be supplied. As ice and water have specific heat capacities of about 2.1 kJ/kgK and 4.2 kJ/kgK, respectively, it is readily seen that a substantial amount of energy is needed to increase the temperature to the melting point for ice and above. The fuel or energy required to heat ice and/or water generally increases operational costs, especially at a typical landfill or tar sand field far from communities that otherwise might have reused the energy.

The initial mixture typically contains agglomerates of rock particles of various sizes embedded in bitumen, as well as larger pieces of rock covered by hydrocarbons. A typical first step is to grind the solid material into solid particles that will not harm downstream equipment.

Grinding agglomerates requires high shear forces compared to the forces required to crush clean, brittle rock. Hence, the agglomerates are typically broken down before or during a mechanical grinding, for example by adding hot water or steam to reduce the viscosity of the bitumen, or by adding volatile solvents to dissolve the bitumen. As noted, heating water consumes much energy, and increase operational costs. Also, volatile solvents tend to evaporate, and must be replaced. Thus, heat and volatile solvents involve losses, i.e. direct operational costs. Hot water, steam and volatile solvents also cause indirect costs as they represent health hazards and other risks that require extra care and/or protective measures. Hence, using hot water, steam and/or volatile solvents increase operational costs.

After grinding, the rock particles preferably have a maximum cross section that will not harm downstream equipment, for example 2-5 mm. The actual maximum size thus depends on the equipment, and may be ensured by passing the particles though a screen. For simplicity, all qualities of rock particles ranging from colloids and clay to light gravel are called “sand” in the following. In other words, the term “sand” as used herein should be construed as rock particles with sizes roughly in the range 1 μm to a few millimetres. Also, water, surfactants or other agents are typically added to create a slurry of hydrocarbons, water, sand, optional additives and possibly ice particles.

The next step is to remove a film or envelope of hydrocarbons from the solid particles, in particular from the sand grains in the slurry.

This can be done, for example, by ultrasound. Examples of acoustic methods and related apparatus are found in e.g. WO 9714765, CA2674246 and U.S. Pat. No. 4,443,320. A disadvantage with methods using ultrasound transducers is related to the efficacy of the transducers. Transducers with high efficacy are more expensive than transducers with lower efficacy. On the other hand, more electric power is needed to drive the less expensive transducers. In either case, investment cost plus operational costs for the transducers required to achieve reasonable process rates make ultrasound a relatively expensive alternative.

Other methods use cavitation, which is a process where microscopic bubbles implode and create forces sufficient to break the adhesion between hydrocarbon and sand. More specifically, the speed of a fluid particle is abruptly increased. According to Bernoulli's law and the principle of conservation of energy, this sudden increase of speed causes an abrupt increase in dynamic pressure, and a corresponding abrupt drop in the local static pressure. If the static pressure falls below the vapor pressure, a bubble appears and implodes shortly after, creating shockwaves with sufficient power to break the adhesion between the hydrocarbon and a solid particle.

US2011163012A1 discloses an apparatus wherein a cylindrical rotor has relatively shallow holes or recesses in its cylindrical face and is surrounded by a cylindrical chamber to form an annular space between them. A slurry containing sand and bitumen is pumped into the annular space. When the rotor spins, a cavitation zone is formed in the annular space, and the resulting cavitation provide the forces required to overcome the adhesion forces between bitumen and the sand. While the wear and tear is relatively small compared to devices where fast rotors are in direct contact with the abrasive slurry, care must be taken to minimize cavitation damage on the rotor and chamber. Further, spinning the rotor at a speed inducing cavitation requires relatively high power supplied to the driving motor. By definition, a high power consumption over time equals a high energy consumption. US2011163012A1 also proposes using separating agent preventing the hydrocarbons from reattaching to the sand, such that sand can be separated in a solid-liquid separator in a subsequent step. The separating agent comprises a wetting agent (surfactant), a hydrotropic agent and a dispersant having flocculating characteristics. All of these compounds are commercially available, and are added in an aqueous solution. Adding a separating agent to the rinsing water adds directly to the operational cost, even if most of the rinsing liquid is reused. The separating agent may also be harmful to the environment.

WO2013172716A1 discloses a method wherein the agglomerates are broken down by grinding, and a residual film of hydrocarbons is stripped from a solid particle by cavitation in a subsequent step. The grinding may be performed in a ball mill in the presence of diesel, light crude or a similar non-volatile mixture of liquid hydrocarbons, which may be recovered together with other hydrocarbons in a later step. Alternatively or in addition, all or some of the grinding may be performed in a cavitator, i.e. a cavitation reactor, in the form of a pipe with jet nozzles mounted in its side walls. Water containing surfactants, i.e. a separating agent, is supplied to the cavitator, where it is ejected as droplets with sufficient speed to cause cavitation when they hit an oil-covered particle within the cavitator. The jets also move the material along the pipe toward a slurry outlet. The separating agent prevents the hydrocarbons from reattaching to the sand, such that sand can be separated in a solid-liquid separator in a subsequent step. After the sand has been removed, the water with surfactants is separated from the hydrocarbons in a liquid-liquid separator and reused. The solid-liquid and liquid-liquid separators are of a conventional type, e.g. hydrocyclones.

US2009261021A1 discloses a similar system, with a reactor in the form of a pipe with nozzles in its sidewalls and subsequent separators, e.g. conventional hydrocyclones.

Neither WO2013172716A1 nor US2009261021A1 describe using hot water or steam, and thus limit the energy consumption. The water consumption is also limited due to recycling.

The main objective of the present invention is to provide an improved method and system that solves at least one of the problems described above, while retaining the benefits of prior art. In particular, the solution should reduce the content of hydrocarbons to a level suitable for landfills, e.g. below 1%, it should consume a minimum of energy and water, have a throughput in the order of tons per hour per unit, and a unit should consume a minimum of space and preferably fit within a standard 20′ container. A further objective is to separate oil from ice using a minimum amount of energy.

### SUMMARY OF THE INVENTION

This objective is achieved by an apparatus according to claim 1 and a system according to claim 7.

In a first aspect, the invention concerns an apparatus for separating hydrocarbons from solid particles. The apparatus comprises a slurry inlet for receiving a slurry comprising water, hydrocarbons and solid particles. A water supply for rinsing water, a slurry outlet providing a residue slurry in a downstream direction, where the apparatus comprising a plurality of nozzles configured to provide rinsing water as droplets with sufficient speed to induce cavitation in the slurry, and separating means for extracting a liquid containing water and hydrocarbons from the slurry and a separate liquid outlet for the extracted liquid.

As noted in the introduction, the solid particles can comprise ice and/or sand. It has been found that ice is partly broken and partly melted by the energy supplied through cavitation. The melted ice is, of course, liquid water in subsequent steps, and any remaining ice forms part of the residue slurry together with sand. Thus, cavitation reduces or eliminates the need for extra heat to melt the ice, and thereby the risk for wasting energy by heating water above the required melting point.

The extracted water and hydrocarbons from the liquid outlet of the apparatus can be separated by a conventional liquid-liquid separator, and the residue slurry containing the solid particles has a lower content of hydrocarbons. In contrast, cavitation reactors from prior art provide sand, oil and water through a common outlet, and thus require a subsequent liquid-solid separation step to remove water containing suspended hydrocarbons from the solid particles. Further, while conventional cavitators rely on a separating agent, e.g. surfactants, to keep the hydrocarbons suspended in water until the liquid can be separated from the solid particles, the apparatus according to the present invention performs the liquid-solid separation sufficiently fast to decrease or remove the need for a separating agent.

Thus, the liquid outlet of the apparatus can be connected to a conventional liquid-liquid separator, the slurry outlet provides a reduced volumetric flow of residue slurry to any subsequent step and the need for separating agents is reduced or eliminated. All of these benefits contribute to lower operational costs.

In an embodiment, the separating means comprise a vertically oriented Archimedes' screw with the slurry outlet at the top and the liquid outlet at the bottom. The vertically oriented screw is preferably inclined to maximize the length, e.g. within a container. Cavitation on the screw is limited as the water jets from the nozzles are directed into the slurry parallel to the helical faces. The residue slurry is conveyed toward the slurry outlet at the top by rotating the screw. Due to the vertical orientation, excess liquid containing water and hydrocarbons flow downward to the liquid outlet at the bottom.

In an embodiment, the separating means comprise a hydrocyclone with an upper cylindrical section and a lower conical section, the upper part of the cylindrical section forming a cavitation chamber. In this embodiment, the slurry inlet is configured to eject the slurry tangentially into the cavitation chamber, the nozzles are directed to support the tangential motion of the slurry within the cavitation chamber, the slurry outlet is located at the bottom of the conical section and the liquid outlet is a pipe extending into an upper, central part of the liquid during operation.

The pipe of the liquid outlet could extend axially through the cavitation chamber, or alternatively through the liquid phase. In either case, the high density sand is forced outwards as it sinks toward the slurry outlet, leaving water with hydrocarbons and possibly ice particles in an upper central part of the swirling matter in the hydrocyclone. This liquid may be removed by a pump or by gravity.

Preferably, the nozzles are directed to provide a radial velocity component for deflecting the slurry from the inner wall of the cavitation chamber. This can be achieved by directing the nozzles into the slurry at an acute angle from the inner cylinder wall, which also reduces undesired cavitation on the inner walls of the apparatus.

In a second aspect, the invention concerns a system for separating hydrocarbons from solid particles comprising an apparatus in either of the embodiments discussed above.

The system may comprise a mixing stage for presenting a slurry comprising water, hydrocarbons and solid particles at an initial slurry outlet. Preferably, the mixing stage comprises a mass tank for an initial mixture with hydrocarbons attached to a solid material; an oil tank for liquid hydrocarbons that can be recovered in a later stage; a grinder configured to grind the solid material into to solid particles with a predetermined maximum size; a mixer for mixing the solid particles with the liquid hydrocarbons and a conveyor for conveying the resulting slurry to the initial slurry outlet.

The mixing stage is known as such. Some of the components of this stage may advantageously be combined, for example the grinder and mixer implemented as a ball mill mentioned in the introduction, or the mixer and conveyor implemented as an Archimedes' screw.

The system can, as an addition or alternative to the mixing stage, comprise a reactor stage with a slurry inlet for receiving a slurry with hydrocarbons attached to solid particles; a cavitation reactor for breaking the adhesion between hydrocarbons and solid particles; a solid-liquid separator connected to a slurry outlet of the cavitation reactor and a slurry outlet for residue slurry from the solid-liquid separator, wherein the slurry outlet of the solid-liquid separator is connected to the slurry inlet of an apparatus according to the first aspect of the invention.

The initial slurry outlet from the mixing stage can be connected to the slurry inlet of the cavitation reactor. In other words, the reactor stage may follow the mixing stage. However, in some applications the mixing stage may be simplified and/or combined with the reaction stage. For example, the initial material may comprise solid particles with a known maximum size that require no grinding, such that agglomerates may be fed directly into the cavitation reactor.

In some embodiments, the solid-liquid separator is a tank with a slurry inlet at the top, a weir protruding into the tank from the bottom, a slurry outlet at the bottom downstream from the weir and a sand outlet in the bottom upstream from the weir.

As sand has a greater density than water, ice and hydrocarbons, a clean rock particle will get a smaller horizontal velocity than water, ice and hydrocarbons given the same momentum, i.e. mass times velocity. Thus, the clean rock particle will travel a shorter horizontal distance than a particle with less density during the time it takes to fall or sink from the height of the inlet to the top of the weir. By adjusting the position and height of the weir, it has been found possible to extract sand, especially larger particles, with a hydrocarbon content below a set limit, e.g. below 1% by weight. The predetermined limit can be set to a regulatory requirement for hydrocarbon content in a landfill, such that the sand from the sand outlet can be removed without further treatment. Removing clean sand from the input slurry reduces the mass flow of residue slurry to the apparatus of the first aspect of the invention, thereby facilitating separation of hydrocarbons from the residue slurry.

In addition to the reactor stage, the system may comprise at least one rinsing stage, wherein each rinsing stage comprises one apparatus according to the first aspect of the invention, and a connection for transporting slurry from the slurry outlet of the previous stage to the slurry inlet of the present stage.

The number of rinsing stages can be adapted to the application at hand, and an output from the final stage will always be sand and water with a predetermined maximum concentration of hydrocarbons from the last slurry outlet, and water with suspended hydrocarbons from the last liquid outlet.

In a preferred embodiment, the system comprises at least two separate water supplies for rinsing water with decreasing concentrations of hydrocarbons in each consecutive water supply from the water supply for the cavitation reactor to the water supply in the last rinsing stage, wherein the liquid outlets of consecutive rinsing stages are connected to separate liquid-liquid separators and each liquid-liquid separator feeds one water supply with recycled rinsing water.

For example, water with a certain content of hydrocarbons from the first rinsing stage can be supplied as process water to the cavitation reactor, whereas rinsing water with less hydrocarbons is supplied to the first rinsing stage from a second rinsing stage, etc. The liquid-liquid separators are required to remove hydrocarbons from the process water during operation. Otherwise, the concentration of hydrocarbons would rise in the process water in all stages. However, the liquid-liquid separators do not have to remove all hydrocarbons from the process water in all stages. Thus, the liquid-liquid separator supplying water to the cavitation reactor in the reactor stage may be of a kind providing a large volumetric flow with a certain content of oil in water, whereas the liquid-liquid separator supplying water to the last rinsing stage can be of a different kind providing low concentrations of hydrocarbons at a lower volumetric flow than the first kind.

Further features and advantages will be apparent from the dependent claims and the detailed description below.

### BRIEF DESCRIPTION OF THE DRAWINGS

The invention will be explained in greater detail by means of exemplary embodiments with reference to the accompanying drawings, in which:

FIG. 1 is a schematic diagram of a system according to the invention;

FIG. 2 illustrates a first embodiment of an apparatus according to the invention;

FIG. 3 is a section of a second embodiment of an apparatus viewed from a side;

FIG. 4 is a section of the second embodiment of an apparatus viewed from the top; and

FIG. 5 illustrates a detail of the reactor stage in the system on FIG. 1;

FIG. 6 is a schematic diagram of a preferred embodiment of the system according to the invention;

FIG. 7 is a more detailed illustration of the reactor pump.

### DETAILED DESCRIPTION OF A PREFERRED EMBODIMENT

The drawings are schematic and intended to illustrate the invention. They are not to scale, and numerous details obvious to one skilled in the art are omitted for clarity. Specifically, some pumps are indicated in the drawings without reference numerals. These make the drawings easier to understand, but describing a pump that is implied by e.g. a pressure increase would just clutter the text with unnecessary detail.

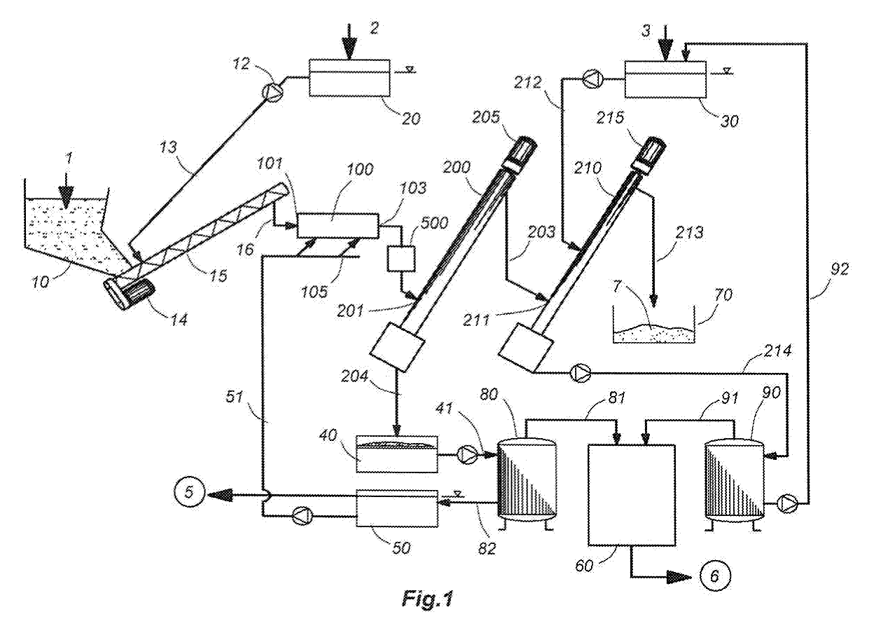

FIG. 1 is a schematic diagram of a system for separating hydrocarbons from solid material, i.e. an initial mixture 1 with pieces of rock and/or ice of arbitrary size with an arbitrary content of hydrocarbons such as oil and/or bitumen. Apart from the mixture 1, a liquid hydrocarbon 2 and water 3 are supplied to the system, in particular to a mixing stage of the system. The mixture 1 depends on the application, and the liquid hydrocarbon 2 is of a kind that may be recovered together with other hydrocarbons at a later stage as described in the introduction. Preferably, no surfactants or other agents are added to the water 3, but it is understood that the invention does not exclude additives.

Desired outputs from the system are excess water 5 of an acceptable quality as described below, hydrocarbons 6 and sand 7 having a concentration of hydrocarbons below a predetermined level, e.g. below 1%. Further treatment of water 5 and the hydrocarbons 6, e.g. separation into market qualities such as diesel oil or into individual hydrocarbons, are not part of the invention. The circles around numerals 5 and 6 indicate optional further treatment.

A general mixing stage is described in the introduction. In FIG. 1, the mixing stage is shown as components 1-20. The output from this stage, at an initial slurry outlet 16, is slurry comprising solid particles of various sizes suitable for the reactor 100 and other downstream equipment. In particular, the mixture 1 is fed from a mass tank 10 into a grinder 15 driven by a motor 14. Liquid hydrocarbons 2 that can be recovered at a later stage, e.g. diesel, domestic heating oil or light crude, is pumped from a solvent tank 20 through line 13 by means of a pump 12.

The next stage, the reactor stage, takes the slurry from line 16 as input, and breaks the adhesion of hydrocarbons and sand and/or breaks ice in a cavitation reactor 100. The cavitation reactor 100 is followed by a solid-liquid separator 500 and/or a sedimentation tank 40 in order to remove a substantial amount of sand as early as possible, thereby reducing the mass flow to subsequent stages. Separation of sand is further explained with reference to FIG. 5.

The reactor stage provides residue slurry at the slurry input 201 of a first rinsing stage. The first rinsing stage comprises exactly one apparatus 200 with a slurry outlet 203 and a separate liquid outlet 204.

The liquid outlet 207 is connected to a buffer tank 40, which in turn is connected to a liquid-liquid separator 80 through line 41. If desired, the buffer tank 40 can be a conventional separation tank.

The slurry outlet 203 of the first rinsing stage is connected to the slurry inlet 211 in a second rinsing stage. The slurry outlet 213 of the final rinsing stage deposits sand 7 and water with a sufficiently low content of hydrocarbons into a sand pit 70.

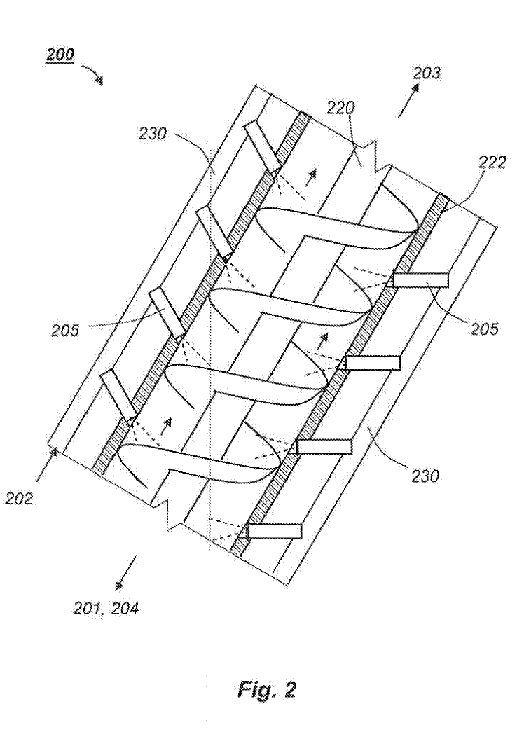

In FIG. 1, an apparatus 200 similar to that of the first rinsing stage is shown in a second rinsing stage. For illustrative purposes, the apparatus in the second rinsing stage has been assigned numeral 211 for its slurry input. This corresponds to the slurry input 201 in the first rinsing stage and FIG. 2. Similarly, the slurry outlet 213 corresponds to the slurry outlet 203, and the liquid outlet 214 corresponds to the liquid outlet 204. It is readily understood that rinsing stages can be added until the sand and water at the slurry outlet 213 of the final rinsing stage has a concentration of hydrocarbons below the predetermined limit.

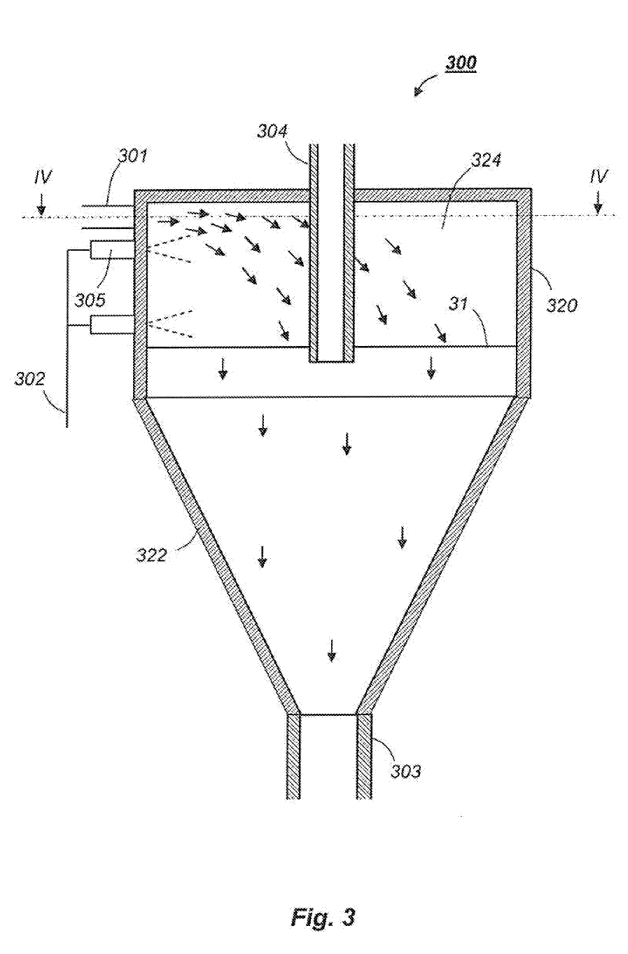

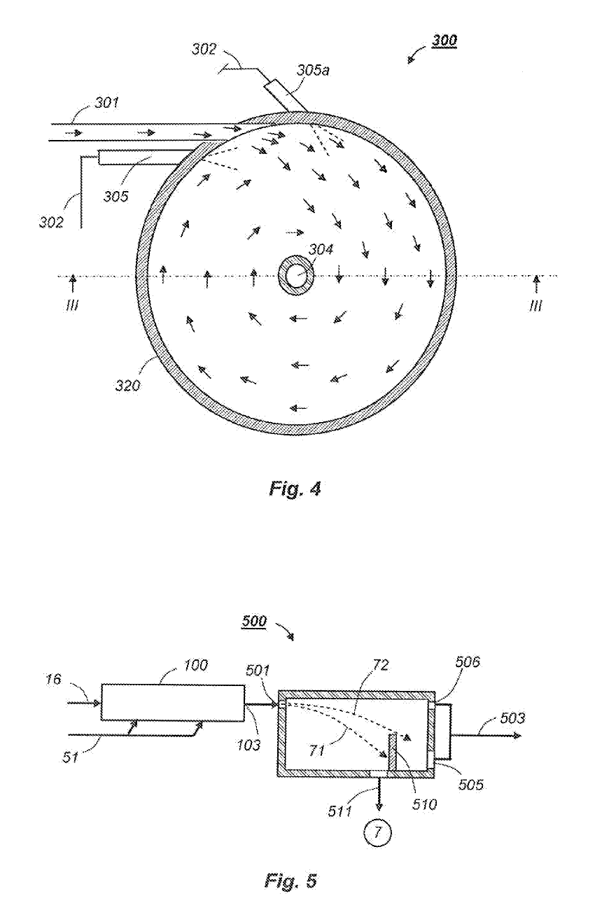

The embodiment of the apparatus 200 in FIG. 2 can be replaced with the alternative embodiment 300 illustrated in FIGS. 3 and 4 in any or all rinsing stage(s). It is understood that if an embodiment 300 replaces an embodiment 200, the slurry inlet 201 is replaced with slurry inlet 301, slurry outlet 303 replaces the corresponding slurry outlet 203, 213 and the liquid outlet 304 replaces the corresponding liquid outlet 204, 214.

Hydrocarbons, possibly with a low concentration of water, are conveyed from separator 80 to an oil tank 60 through line 81. Water, possibly with a low content of hydrocarbons, is conveyed from separator 80 to a water tank 50 through line 82.

As the slurry in the reactor stage contains more hydrocarbons than the residue slurry in the subsequent rinsing stages, the concentration of hydrocarbons in the process water in the reactor stage can be higher than in subsequent rinsing stages. Thus, the reactor 100 is preferably supplied with water from the water tank 50 through line 51 rather than with clean water 3 from the clean water tank 30. The water from water tank 50 may contain a small amount of hydrocarbons, but at a substantially lower concentration than the input slurry supplied through line 16. Accordingly, excess water 5 may need further treatment, e.g. for use in later rinsing stages or for meeting environmental requirements before the water is disposed of, for example into a public waste water network, into a local pit or into the ocean. If desired, the excess water 5 from tank 50 could be treated in liquid-liquid separators in the rinsing stages of the system.

Preferably, the reactor stage is optimized for volume flow, e.g. such that the reactor 100 is adapted to clean large particles fast and passing smaller particles to the next stage, and such that the first liquid-liquid separator 80 produces a large volume of sufficiently clean process water rather than a using more time to obtain a lower concentration of residue hydrocarbons. For this, the reactor 100 is preferably a cavitator of the kind described in WO2013172716A1 and mentioned in the introduction. The first liquid-liquid separator 80 is typically a commercially available hydrocyclone with the desired properties.

In general, each stage, including the reactor stage, may have a recirculation path for process water with a sufficiently low concentration of hydrocarbons, as opposed to an unnecessary low concentration, in order to limit the volume of process water to be cleaned and the extent to which it has to be cleaned. The reduced operational costs should of course outweigh the investments cost for additional recirculation paths.

The output residue slurry from pipe 203 enters the slurry inlet 211 in a subsequent apparatus 210 in a subsequent rinsing stage. The apparatus 210 receives clean process water 3 from the tank 30, as the process water from tank 50 may contain too much residue oil to clean the residue slurry efficiently. Clean sand 7 and some process water from the slurry outlet 213 is deposited in a sand pit 70. More precisely, the sand 7 contains solid particles with various sizes and a concentration of hydrocarbons below a predetermined threshold as described previously.

Liquid from the second apparatus 210 is pumped from a liquid outlet 214 into a second separator 90. The second separator 90 provides lower concentrations of hydrocarbons in water than the first separator 80, and may thus be of a different kind than the first separator 80. Hydrocarbons are conveyed from the second separator 90 to the oil tank 60 through line 91. Water, possibly with a very low concentration of hydrocarbons, is conveyed from the second separator 90 to the clean water tank 30 through line 92.

In general, each stage in the system could include a liquid-liquid separator such as the first and separators 80, 90, whereas in the example on FIG. 1 the first separator 80 is common to reactor 100 and first apparatus 200. Any excess water from the second separator 90 is assumed to be sufficiently clean for disposal. Thus, no explicit line for excess water is shown from separator 90.

As mentioned, an optional treatment of the hydrocarbons 6 is beyond the scope of the present invention. Accordingly, hydrocarbons from the liquid-liquid separators 80, 90 are collected in the common oil tank 60. The oil from oil tank 60 is likely to contain some water, and the further treatment may include a step of further reducing the content of water in a liquid-liquid separator. Variations of the system wherein oil is treated separately at each stage may be considered. For example, a liquid-liquid separator at some stage might produce oil that does not require further treatment. In this case, it might be more efficient to store this oil in a separate tank than mixing it with water in the common oil tank 60.

FIG. 2 illustrates an embodiment of an apparatus for separating hydrocarbons from solid, inorganic material according to the invention. The apparatus 200 comprises an Archimedes' screw with a screw 220 rotatably disposed within a pipe 222. Preferably, the screw 220 and pipe 222 are in close contact around the entire circumference such that sand cannot pass between them and flow to the liquid outlet 204.

During operation, the screw 220 rotates within the pipe 222 such that the slurry input at an inlet 201 is conveyed in the direction indicated by small arrows. Process water is supplied through an inlet 202 and a water pipe 230, and ejected at high speed from nozzles 205 embedded in the walls of pipe 222. The pressure within the water pipe 230 and the nozzle diameters are adapted to cause cavitation within the slurry, whereby the adhesion between solid particles and hydrocarbons is broken.

In order to avoid unwanted cavitation on the screw 220, the jets from nozzles 205 are directed along the helical faces of the screw and into the slurry. In the apparatus 200, the jets have a velocity component directed opposite to the velocity field for sand indicated by arrows. A first effect of directing the water opposite the flow of sand is that the water carries hydrocarbons to the bottom of the device, i.e. the outlet 204. More specifically, water and hydrocarbons have substantially less density than the sand, such that inertia transferred from a droplet in the jet tends to move hydrocarbons downwards, whereas the velocity of a heavier sand particle is less affected. A second effect is that additional energy must be supplied to overcome the effect of the longitudinal counter current of water and possibly to lift the slurry. In FIG. 2, this additional energy is supplied through rotation of the screw 220. A motor 205, 215 for rotating the screw 220 is shown at the top of each apparatus 200, 210 in FIG. 1.

The second apparatus 210 in FIG. 1 is similar to the embodiment in FIG. 2. Referring to FIGS. 1 and 2, slurry is input at inlets 201 and 211 respectively. The line 212 for pressurized water is connected to the water pipe 230 in FIG. 2. A similar waterfeed to the apparatus 200 is not shown explicitly in FIG. 1 for reasons of clarity. However, pressurised water must be supplied through the nozzles 205 for both devices 200, 210. If process water at high speed is not supplied to the apparatus 200, there will be no cavitation.

The apparatuses 200, 210 in FIGS. 1 and 2 are shown inclined with respect to the vertical to illustrate that the system is intended for a confined space, e.g. a standard 20′ container. From the description of FIG. 2, it is realised that the cleaning effect of an apparatus 200, 210 increases with the length of the unit. As the length of a hypotenuse in a right angled triangle is greater than any of the catheti, an inclined apparatus 200, 210 can be longer than an apparatus mounted parallel to one of the walls or to the floor of a standard container.

FIGS. 3 and 4 illustrate an embodiment 300 of an apparatus according to the invention. FIG. 3 is a cross sectional view along plane III-III FIG. 4, i.e. viewed from a side. FIG. 4 is a cross sectional view along plane IV-IV in FIG. 3, i.e. viewed from the top.

The embodiment 300 has a cylindrical top section 320, a conical bottom section 322, a slurry inlet 301, a water inlet 302 for process water, a sand outlet 303 and a liquid outlet 304. During operation, the slurry inlet 301 feeds slurry tangentially into a cavitation chamber 324 at the top of cylindrical section 320. Process water is injected through nozzles 305 with sufficient speed to induce cavitation. Some process water is injected in the same direction as the slurry to enhance the effect of the hydrocyclone immediately below the cavitation chamber 324, and some process water is injected radially to deflect the slurry from the cylinder walls within the cavitation chamber.

During operation, the adhesion between sand and hydrocarbons is broken as the particles fall through the cavitation chamber. In the swirling liquid below, i.e. in the hydrocyclone, the dense sand moves radially outward toward the walls as they fall toward the slurry outlet 303 as indicated by the small arrows. The less dense water and hydrocarbons move radially inward and up to a central area at the top of the swirling liquid, i.e. to the liquid outlet 304.

FIG. 3 is simplified for illustration. For example, the liquid surface 31 is depicted as a straight line, whereas the rotating liquid actually forms a vortex rather than a plane surface as suggested by line 31. More importantly, a pipe 304 extending through the cavitation chamber 324 is of course prone to undesired cavitation. Thus, in a practical implementation, the pipe 304 could extend through the liquid into the upper central area to remove water and oil without sand. The input velocity of the slurry, geometry and other design parameters for the hydrocyclone part below the cavitation chamber are known in the art. In particular, the entire body 320, 322 may advantageously be made of steel lined with polyurethane, similar to the materials in a conventional hydrocyclone.

FIG. 5 illustrates the separation tank 500 in FIG. 1. The output from reactor 100 is a mixture of water, hydrocarbons and solid particles with various amounts of hydrocarbon attached to them, i.e. from clean sand grains with no hydrocarbons attached to sand grains completely covered by hydrocarbons.

This mixture is supplied to a slurry inlet 501 in a separation tank 500. It is readily understood that the inlet can be extended laterally, i.e. in the direction perpendicular to the paper plane in FIG. 5 to accommodate the volume flow from the reactor 100. A continuous laminar, steady flow is assumed in the downstream direction from the inlet 501 to a residue slurry output 504, i.e. from left to right in FIG. 5. A weir 510 is provided at the bottom of the tank at a horizontal distance from the inlet 501.

Trajectory 71 illustrates what happens to a sand particle with little or no hydrocarbons attached. This particle has a density approximately equal to that of sand, and relatively small buoyancy. Thus, it sinks relatively fast mainly due to gravity. At the same time, the first particle moves horizontally at approximately constant speed. The resulting trajectory is shown at reference numeral 71, and ends in the weir 510.

Trajectory 72 is associated with a second particle comprising a sand particle identical to the first particle, but with hydrocarbons attached. Because liquid and sand flow through the tank 500, the increased cross section of the second particle does not affect its horizontal speed, and the second particle can safely be assumed to travel at the same horizontal speed as the first particle. However, the second particle does have a smaller density and higher buoyancy than the first particle. Accordingly, the net downward force acting on the second particle is smaller than that acting on the first particle. In the example in FIG. 5, the second particle almost, but not quite, reaches the top of weir 510 in the time used to travel from inlet 501 to weir 510 at the constant horizontal velocity. The resulting trajectory is indicated by reference numeral 72.

In effect, the horizontal length from the inlet 501 to the weir 510 and the height of weir 510 determines the amount of hydrocarbons that can be attached to a sand particle. For a given horizontal distance, a lower weir 510 means that a wider range of densities passes over the weir 510, and hence that the sand 7 is cleaner than it would have been with a higher weir.

Solid particles with a density above a predetermined limit set by the weir 510, is removed through sand outlet 503 upstream from the weir 510. Particles comprising sand and hydrocarbons with densities below the predetermined limit, such as the second particle above, will pass the weir 510 as illustrated by trajectory 72, and collect near the outlet 505. Hydrocarbons have densities lower than the density of water, and will float up during the flow along the separation tank 500. However, the purpose of the tank 500 is to remove a reasonable fraction of clean sand, and the liquid is not likely to stay sufficiently long in the tank 500 to achieve a useful separation of water and hydrocarbons. The water with hydrocarbons from opening 506 is therefore removed together with residue slurry from opening 505 through the slurry outlet 503, which in turn is connected to the slurry inlet 201 or 301 in the next stage.

In general, throughput and size are driving design parameters for the system as a whole, and also for the separation tank 500. This means that the distance between inlet 501 and weir 510 should be as short as possible in order to extract a substantial amount of clean sand 7. Reduced horizontal fluid velocity or a larger length of the separation tank 500 would reduce throughput and/or increase the size of the system. Hence, the hydrocarbons should not be allowed more time to float up than the time required for separating clean sand 7 as described.

From the above description of the separator tank 500, it should be clear that its operation would be disturbed by powerful convection or vortices. Thus, it may be desirable to provide e.g. a tray and vertical vanes (not shown) at the inlet 501 to ensure a substantially laminar flow into the separation tank 500. Further, the time required for a particle to move from the outlet of reactor 100 to the slurry outlet 503 should not allow a substantial amount of hydrocarbons to reattach to the solid particles. Adapting the length of separator tank 500, including any tray, to the laminar flow velocity is trivial.

Tests using a cavitator as described in WO2013172716A1 as the reactor 100 and a separator tank using the principle illustrated in FIG. 5, show that a substantial amount of clean sand 7 indeed can be conveyed from the sand outlet 503 to the sand pit 70 without further treatment. Thus, a separator tank 500 using these principles is an inexpensive and efficient part of a system according to the invention, e.g. as illustrated in FIG. 1. The tests also verify that the sand 7 at outlet 503 contains predominantly large particle sizes.

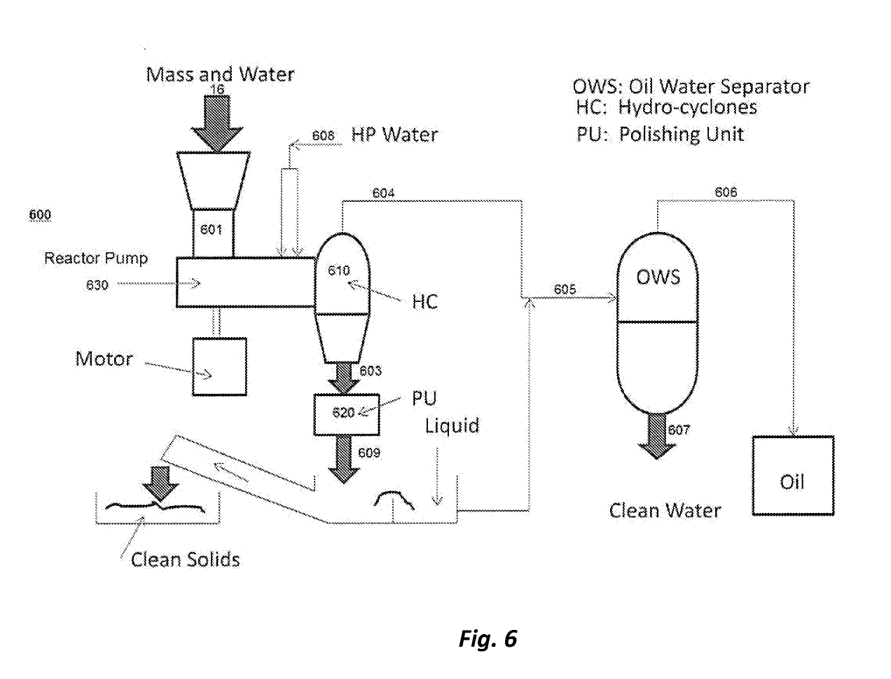

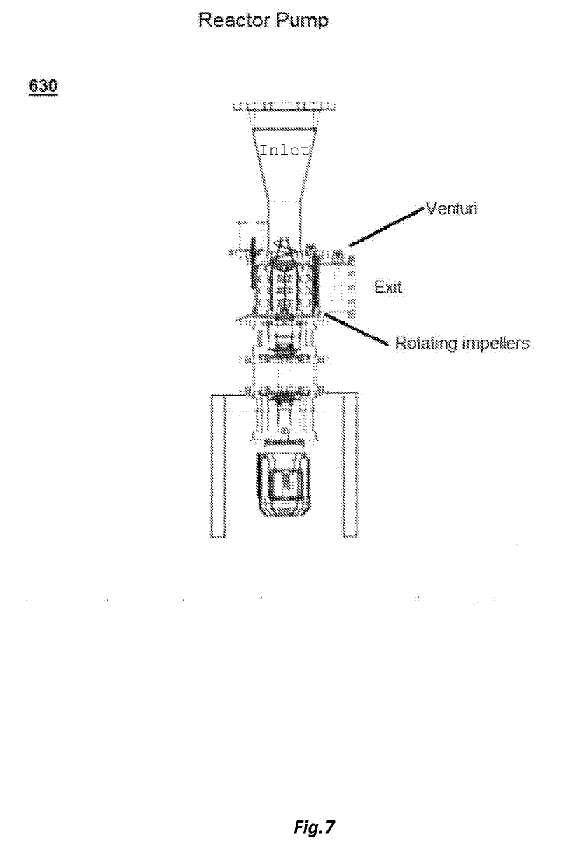

FIG. 6 illustrates a most preferred embodiment of the invention where the cavitation reactor 100 and the solid-liquid separator 500 are replaced with a reactor pump 630. FIG. 7 illustrates the reactor pump 630 more detailed. The device 200 for extraction liquid comprising hydrocarbons and water, from the slurry, is replaced by a battery of hydrocyclones 610 as shown in the simplified process diagram of FIG. 6. The devices 80 and 90 for separation of oil and water may also be replaced by one Oil Water Separator (OWS).

FIG. 6 schematically illustrates a process utilizing the reactor pump 630 having the following functions:
Homogenization of the material subject to treatment.
Reducing/eliminating the bonding forces between the organic and inorganic materials by introducing the effect of cavitation to the mass subject to treatment.
Creating adequate process-pressure for one or a battery of hydrocyclone(s) 610 mounted at the exit port of the reactor pump 630.

The above arrangement significantly simplifies the overall process treatment plant. It is essential that the reactor pump is designed for maintaining a constant and controllable cavitation effect. The lifetime of the reactor pump is multiplied compared to standard pumps or rebuild standard pumps that attempted used in conjunction with cavitation.

A detailed description of the reactor pump is disclosed in the following. The material containing hydrocarbons or heavy metals is liquefied with water to become a slurry prior to entering the reactor pump (630). The main items of the reactor pump comprise a plurality, but preferably, two to six impellers/flaps hinged to a vertical rotor shaft mounted in the pump housing. Each impeller/flap has one or more openings pertaining to the required pressure by the hydrocyclones. The slurry enters the impellers axially and is discharged radially through one or more high pressure venture-jets of water mounted at the pump exit housing and in front of the hydrocyclones. Thereby an additional effect of cavitation is addressed to the outgoing flow of slurry. The impellers or flaps are attached to the rotor shaft by hinges due to the need for absorbing impact shocks from the presence of larger particles in the slurry. The impellers are rotating at 3000 RPM or more and will therefore, theoretically and in many ways, behave similar to the elements of an axial flow pump and for all practical purpose be compared to a cavitating propeller. According to Bernoulli's theorem, the increase in the velocity of the water dominated slurry is accompanied by decrease in the water pressure down to the vapor pressure on the suction side of the impellers. Therefore, the water boils locally and vapor bubbles are formed. When the bubbles enters the region of higher pressure towards the exit area of the pump, the bubbles implode releasing the high energy of cavitation. At this instant, the bonding forces between the organic and inorganic materials are eliminated. Additional venturi-jets of cavitating water are entering at the exit pump housing through dedicated nozzles in order to secure prolonged effect of cavitation. If the materials are not subject to a continuous separation process, the bonding between the organic and inorganic materials will be re-established in the short period of 15 to 20 seconds. The hydrocyclones are therefore mounted close to or directly on to the reactor pump exit flange separating hydrocarbons, heavy metals and liquid from the inorganic material. In FIG. 6, ref. 600 illustrates the one or more hydrocyclone(s) 610 mounted directly on the exit port of the reactor pump 630.

A polishing or washing process 620 could also be included, downstream the hydrocyclones. This device could be included in cases where it occurs extra bonds between organic and in-organic materials because of chemicals or if there are required high purity of the in-organic material intended for free disposal.

While the invention has been described by way of exemplary embodiments, the scope of the invention is defined by the attached claims.

1. An apparatus for separating hydrocarbons from solid particles, the apparatus comprising:
a slurry inlet for receiving a slurry comprising water, hydrocarbons and solid particles;
a water supply for rinsing water;
a slurry outlet providing a residue slurry in a downstream direction;
a plurality of nozzles configured to provide rinsing water as droplets with sufficient speed to induce cavitation in the slurry;
a separator for extracting a liquid containing water and hydrocarbons from the slurry; and
a separate liquid outlet for the extracted liquid.

2. The apparatus according to claim 1 further comprising a reactor pump with a slurry inlet for receiving a slurry with hydrocarbons attached to solid particles, the reactor pump comprising:
homogenizations means for breaking up lumps of organic materials; and
cavitation means for breaking the adhesion between hydrocarbons and solid particles;
pressurization means customized for one or more hydrocyclone(s) mounted directly on the exit port of the reactor pump;
a liquid outlet for the extracted liquid; and
a slurry outlet.

3. The apparatus according to claim 2, wherein the reactor pump further comprises a plurality of impellers/flaps hinged to a vertical rotor shaft mounted in a pump housing,
wherein each impeller/flap has one or more openings pertaining to the required pressure by the hydrocyclone(s), and
the slurry enters the impellers axially and is discharged radially through one or more high pressure venture-jet(s) of water mounted at the pump exit housing and in front of the hydrocyclones.

4. The apparatus according to claim 1, wherein the separator comprises a vertically oriented Archimedes' screw with the slurry outlet at the top and the liquid outlet at the bottom, and
wherein the nozzles are directed substantially parallel to the helical faces of the screw.

5. The apparatus according to claim 1, wherein the separator comprises a hydrocyclone with an upper cylindrical section and a lower conical section, the upper part of the cylindrical section forming a cavitation chamber,
wherein the slurry inlet is configured to eject the slurry tangentially into the cavitation chamber,
wherein the nozzles are directed to support the tangential motion of the slurry within the cavitation chamber,
wherein the slurry outlet is located at the bottom of the conical section, and
wherein the liquid outlet is a pipe extending into an upper central pan of the liquid during operation.

6. The apparatus according to claim 5, wherein the nozzles are directed to provide a radial velocity component for deflecting the slurry from the inner wall of the cavitation chamber.

7. A system for separating hydrocarbons from solid particles comprising the apparatus according to claim 1.

8. The system according to claim 7, further comprising a mixing stage for presenting a slurry comprising water, hydrocarbons and solid particles at an initial slurry outlet.

9. The system according to claim 8, wherein the mixing stage comprises:
a muss tank for an initial mixture with hydrocarbons attached to a solid material;
an oil tank for liquid hydrocarbons that can be recovered in a later stage;
a grinder configured to grind the solid material into solid particles with a predetermined maximum size;
a mixer for mixing the solid particles with the liquid hydrocarbons; and
a conveyor for conveying the resulting slurry to the initial slurry outlet.

10. The system according to claim 7 further comprising:
a reactor stage with a slurry inlet for receiving a slurry with hydrocarbons attached to solid particles;
a cavitation unit for breaking the adhesion between hydrocarbons and solid particles; and
a solid-liquid separator connected to a slurry outlet of the cavitation unit and a slurry outlet for residue slurry from the solid-liquid separator,
wherein the slurry outlet of the solid-liquid separator is connected to the slurry inlet of said apparatus,
wherein the separator comprises a vertically oriented Archimedes' screw with the slurry outlet at the top and the liquid outlet at the bottom, and
wherein the nozzles are directed substantially parallel to the helical faces of the screw.

11. The system according to claim 7 further comprising:
a reactor pump with a slurry inlet for receiving a slurry with hydrocarbons attached to solid particles, wherein the reactor pump comprises cavitation means, homogenization means for breaking up lumps of organic materials, and pressurization means customized for one or more hydrocyclone(s) mounted directly on the exit port of the reactor pump;
a liquid outlet for the extracted liquid; and
a slurry outlet, wherein the initial slurry outlet from the mixing stage is connected to the slurry inlet of the cavitation unit.

12. The system according to claim 8, wherein the initial slurry outlet from the mixing stage is connected to the slurry inlet of the cavitation unit.

13. The system according to claim 10, wherein the solid-liquid separator is a tank with a slurry inlet at the top, a weir protruding into the tank from the bottom of a slurry outlet at the bottom downstream from the weir and a sand outlet in the bottom upstream from the weir.

14. The system according to claim 10, further comprising at least one rinsing stage, wherein each rinsing stage comprises:
one of said apparatus; and
a connection for transporting slurry from the slurry outlet of the previous stage to the slurry inlet of the present stage.

15. The system according to claim 14, further comprising at least two separate water supplies for rinsing water with decreasing concentration of hydrocarbons in each consecutive water supply from the water supply for the cavitation reactor/reactor pump to the water supply in the last rinsing stage,
wherein the liquid outlets of consecutive rinsing stages are connected to one Oil Water Separator or separate liquid-liquid separators and each liquid-liquid separator feeds one water supply with recycled rinsing water.

16. A system for separating hydrocarbons from solid particles comprising the apparatus according to claim 2.

17. A system for separating hydrocarbons from solid particles comprising the apparatus according to claim 3.

18. A system for separating hydrocarbons from solid particles comprising the apparatus according to claim 4.

19. A system for separating hydrocarbons from solid particles comprising the apparatus according to claim 5.

20. A system for separating hydrocarbons from solid particles comprising the apparatus according to claim 6.
